(19) United States
(12) Patent Application Publication
(10) Pub. No.: US 2017/0337372 A1
(43) Pub. Date: Nov. 23, 2017

(54) Maliciousness Categorization of Application Packages Based on Dynamic Analysis

(71) Applicant: Trustlook Inc., San Jose, CA (US)

(72) Inventors: Liang Zhang, Pleasanton, CA (US); Jinjian Zhai, Union City, CA (US)

(21) Appl. No.: 15/158,452

(22) Filed: May 18, 2016

(51) Int. Cl. G06F 21/53; G06N 99/00

(52) U.S. Cl. CPC G06F 21/53; G06N 99/005; G06F 2221/033

(57) ABSTRACT

An analysis system performs a dynamic analysis of application packages. In one aspect, the application package is configured for installation on a client device, and the analysis system includes an instrumented simulation engine for the client device. The application package is executed on the instrumented simulation engine. The behavior of the application package is recorded, and the application package is categorized (e.g., as benign or malicious) based on its behaviors.

### BACKGROUND

### 1. Technical Field

The present invention relates generally to the field of application and data security and, more particularly, to the detection and classification of malware.

### 2. Background Information

The ubiquity of electronic devices, particularly mobile devices, is an ever-growing opportunity for cybercriminals and hackers who use malicious software (malware) to invade users' personal lives, to develop potentially unwanted applications (PUA) such as riskware, pornware, risky payment apps, hacktool and adware, and to bring unpleasant experience in smart phone usage. Cybercriminals can use malware and PUA to disrupt the operation of mobile devices, display unwanted advertising, intercept messages and documents, monitor calls, steal personal and other valuable information, or even eavesdrop on personal communications. Examples of different types of malware include computer viruses, trojans, rootkits, ransomware, bots, worms, spyware, scareware, exploit, shell, and packer. As the number of electronic devices and software applications for those devices grows, so do the number and types of vulnerability and the amount and variety of software that is hostile or intrusive. Malware can take the form of executable code, scripts, active content and other software. It can also be disguised as, or embedded in, non-executable files such as PNG files. In addition, as technology progresses at an ever faster pace, malware can increasingly create hundreds of thousands of infections in a period of time (e.g., as short as a few days).

Thus, it is important to detect new types of malware as they are introduced into the technology ecosystem. However, given technology trends, this task is becoming ever more difficult due to the increasing number and variety of devices, vulnerabilities and malware. Furthermore, it must be accomplished in ever shorter time periods due to the increasing speed with which malware can proliferate and cause damage.

### SUMMARY

Various drawbacks of the prior art are overcome by providing an analysis system that performs a dynamic analysis of application packages. In one aspect, the application package is configured for installation on a client device, and the analysis system includes a physical or instrumented simulation engine for the client device. The application package is executed on the engine. The behavior of the application package is recorded, and the application package is categorized (e.g., as benign or malicious) based on its behaviors.

Other aspects include components, devices, systems, improvements, methods, processes, applications, computer readable mediums, and other technologies related to any of the above.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a high-level block diagram illustrating a technology environment that includes an analysis system that protects the environment against malware, according to one embodiment.

FIG. 2 is a high-level block diagram illustrating an analysis system for detecting malwares, according to one embodiment.

FIG. 3 is a high-level block diagram illustrating a behavior observation module for generating behavior tokens of software application packages, according to one embodiment.

FIG. 4 is a high-level block diagram illustrating an example of a computing device for use as one or more of the entities illustrated in FIG. 1, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

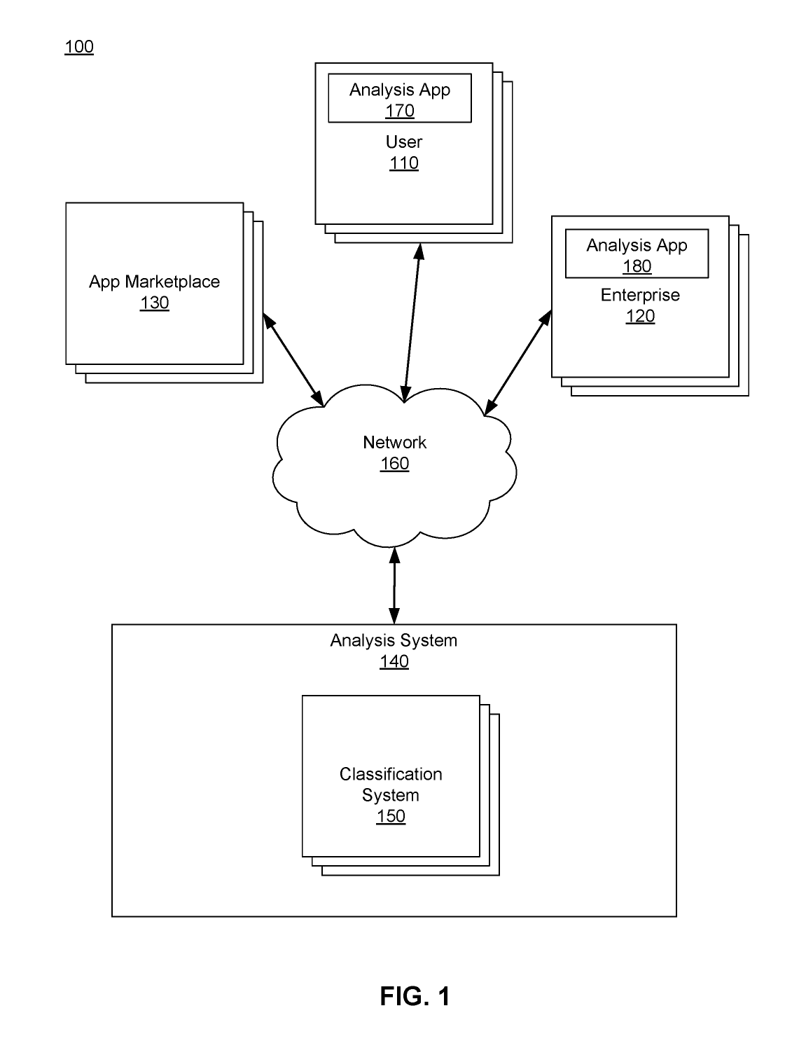

FIG. 1 is a high-level block diagram illustrating a technology environment 100 that includes an analysis system 140, which protects the environment against malware, according to one embodiment. The environment 100 also includes users 110, enterprises 120, application marketplaces 130, and a network 160. The network 160 connects the users 110, enterprises 120, app markets 130, and the analysis system 140. In this example, only one analysis system 140 is shown, but there may be multiple analysis systems or multiple instances of analysis systems. The analysis system 140 provides security vulnerabilities (e.g., malware, viruses, spyware, trojans, etc.) detection services to the users 110. The users 110, via various electronic devices (not shown), receive security vulnerability such as malware detection results from the analysis system 140. The users 110 may interact with the analysis system 140 by visiting a website hosted by the analysis system 140. As an alternative, the users 110 may download and install a dedicated application to interact with the analysis system 140. The users 110 may download and install a dedicated application to interact with the analysis system 140. A user 110 may sign up to receive security vulnerability detection services such as receiving a comprehensive overall security score indicating whether a device or application or any file is safe or not, malware or virus scanning service, security monitoring service, and the like.

User 110 devices include computing devices such as mobile devices (e.g., smartphones or tablets with operating systems such as Android or Apple IOS), laptop computers, wearable devices, desktop computers, smart automobiles or other vehicles, or any other type of network-enabled device that downloads, installs, and/or executes applications. A user device may query a detection API and other security scanning APIs hosted by the analysis system 140. A user device may detect malware based on the local dynamic analysis engine embedded in an application installed in its read only memory (ROM). A user device typically includes hardware and software to connect to the network 160 (e.g., via Wi-Fi and/or Long Term Evolution (LTE) or other wireless telecommunication standards), and to receive input from the users 110. In addition to enabling a user to receive security vulnerability detection services from the analysis system 140, user devices may also provide the analysis system 140 with data about the status and use of user devices, such as their network identifiers and geographic locations.

The enterprises 120 also receive security vulnerabilities (e.g., malware, viruses, spyware, trojans, etc.) detection services provided by the analysis system 140. Examples of enterprises 120 include a corporation, university, and government agency. The enterprises 120 and their users may interact with the analysis system 140 in at least the same ways as the users 110, for example through a website hosted by the analysis system 140 or via dedicated applications installed on enterprise devices. Enterprises 120 may also interact in different ways. For example, a dedicated enterprise-wide application of the analysis system 140 may be installed to facilitate interaction between enterprise users 120 and the analysis system 140. Alternately, some or all of the analysis system 140 may be hosted by the enterprise 120. In addition to individual user devices described above, the enterprise 120 may also use enterprise-wide devices.

Application marketplaces 130 distribute software applications to users 110 and enterprises 120. An application marketplace 130 may be a digital distribution platform for mobile application software or other types of computer software. A software publisher (e.g., developers, vendors, corporations, etc.) may release a software application package to the application marketplace 130. The software application package may be available for the public (i.e., all users 110 and enterprises 120) or specific users 110 and/or enterprises 120 selected by the software publisher for download and use. In one embodiment, the application being distributed by the application marketplace 130 is a software package in the format of Android application package (APK). Although the examples below refer to APKs, that is not a limitation. In other embodiments, the application being distributed may alternatively and/or additionally be software packages in other forms or file formats.

The analysis system 140 provides security vulnerabilities detection services, such as malware detection services, to users 110 and enterprises 120. The analysis system 140 detects security threats on the user devices of the users 100 as well as on the enterprise devices of the enterprises 120. The user devices and the enterprise devices are hereinafter referred together as the “client devices” and the users 110 and enterprises 120 as “clients”. In various embodiments, the analysis system 140 analyzes APKs of the applications to detect malicious applications. APKs of the applications are identified by unique APK IDs, such as a hash of the APK. The analysis system 140 may notify a client of the malicious applications installed on the client device. The analysis system 140 may notify a client responsive to determining that the client is attempting to install or has installed a malicious application on the client device. The analysis system 140 analyzes new and existing APKs. New APKs are APKs that are not known to the analysis system 140 and for which the analysis system 140 does not yet know whether the APK is malware. Existing APKs are APKs that are already known to the analysis system 140. For example, they may have been previously analyzed by the analysis system 140 or they may have been previously identified to the analysis system 140 by a third party, for example, using signature based detection modules.

If the APK is new to the analysis system 140), the analysis system 140 analyzes the new application to determine whether it is malware or other security vulnerability. The analysis system 140 receives new APKs in a number of ways. As one example, the dedicated application of the analysis system 140 that is installed on a client device (e.g., analysis apps 170 and 180) identifies new APKs and provides them to the analysis system 140. As another example, the analysis system 140 periodically crawls the app marketplace 130 for new APKs. As a further example, the app marketplace 130 periodically provides new APKs to the analysis system 140, for example, through automatic channels.

For existing APKs, the analysis system 140 may apply regression testing to verify analysis of existing APKs. New models may be applied to analyze existing APKs to verify detection of malware and other security vulnerability. For example, the analysis system 140 may over time be enhanced with the ability to detect more malicious behaviors. Thus, the analysis system 140 analyzes the existing APKs that have been analyzed previously to identify whether any of the existing APKs that were detected to be benign are in fact malicious, or vice versa.

The analysis system 140 includes one or more classification systems 150 that may apply different techniques to classify an APK. For example, a classification system 150 analyzes system logs of an APK to detect malicious codes thereby to classify the APK. As another example, a classification system 150 traces execution of the application such as control flows and/or data flows to detect anomalous behavior thereby to classify an APK. The analysis system 140 maintains a list of identified malicious APKs.

The network 160 is the communication pathway between the users 110, enterprises 120, application marketplaces 130, and the analysis system 140. In one embodiment, the network 160 uses standard communications technologies and/or protocols and can include the Internet. Thus, the network 160 can include links using technologies such as Ethernet, 802.11, InfiniBand, PCI Express Advanced Switching, etc. Similarly, the networking protocols used on the network 160 can include multiprotocol label switching (MPLS), transmission control protocol/Internet protocol (TCP/IP), User Datagram Protocol (UDP), hypertext transport protocol (HTTP) and secure hypertext transport protocol (HTTPS), simple mail transfer protocol (SMTP), file transfer protocol (FTP), etc. The data exchanged over the network 160 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 160 can use custom and/or dedicated data communications technologies instead of, or in addition to, the ones described above.

The analysis apps 170 and 180 are dedicated apps installed on a user device and an enterprise device, respectively. When installing an APK, the analysis app 170, 180 compares the APK ID to the analysis results from the analysis system 140. The analysis results include malicious applications that are identified by the APK IDs. If the new APK ID matches the APK ID of a known malicious APK, the analysis app 170, 180 alerts the user of the security threat and/or takes other appropriate action.

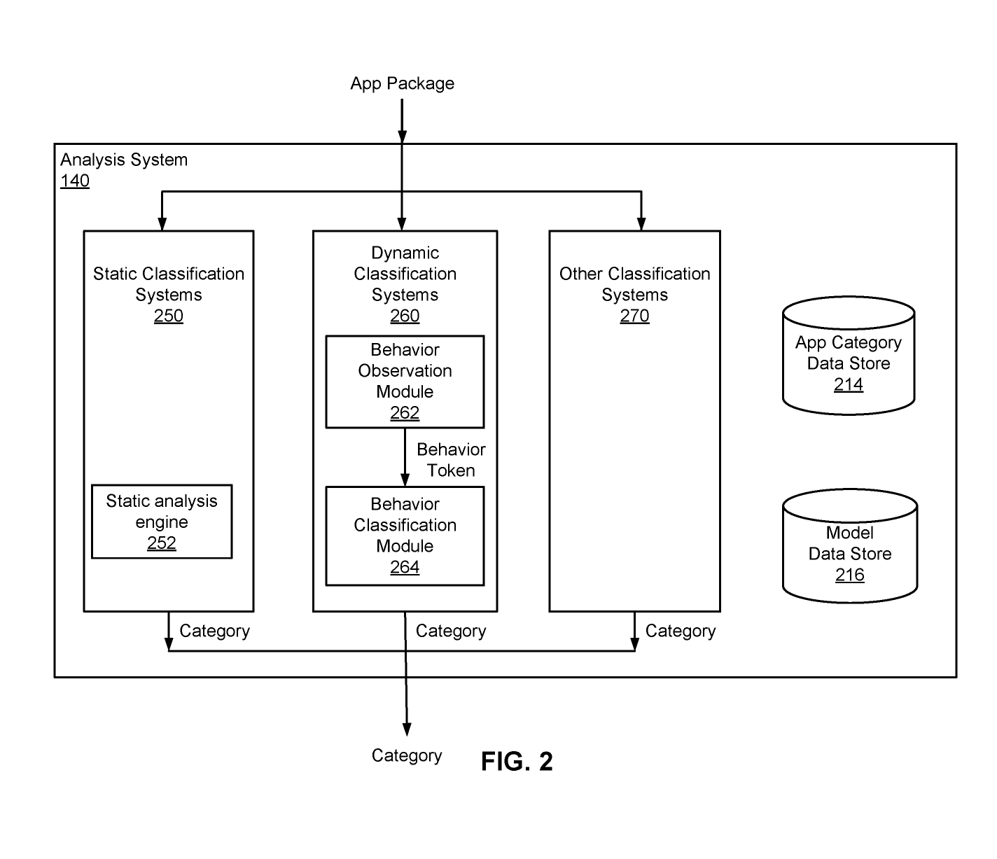

FIG. 2 is a high-level block diagram illustrating an analysis system 140 for detecting security vulnerabilities, according to one embodiment. The analysis system 140 receives a software package. The analysis system 140 stores and maintains prior analysis results of the APKs in the app category data store 214. Each application is identified by the APK ID and associated with a category (e.g., malicious or benign) classified by the analysis system 140. An application may be further associated with metadata (e.g., version, release time, etc.) If the APK ID of the received software package cannot be located in the list, then it is a new APK to be analyzed. In some embodiments, the analysis system 140 distributes the analysis results which are a list of APK IDs and categories associated with the APK IDs to client devices. If an application is being installed, a client device queries the APK ID in the list of applications that have been analyzed. If the APK ID is not included in the list of applications, the client device provides the software package of the particular application to the analysis system 140 for vulnerability analysis.

The software application package is classified by one or more classification systems 250, 260, 270 included in the analysis system 140. Each classification system classifies the software application package into a category (e.g., benign or malicious). In this example, the classification systems include static classification systems 250 and dynamic classification systems 260. One of ordinary skill in the art would appreciate that the analysis system 140 can include classification systems 270 that use other techniques to classify an application. The categorizations from the different classification systems are combined to produce an overall category for the application. For example, in one approach, if any classification system classifies the application as malware, then the overall classification is malware. As another example, rules that are based on domain knowledge of mobile security researches are used to resolve conflicting detection results by different classification systems. Conflicting detection results may be provided to an expert for further analysis where ground truth of the sample can be determined and corrections are made based on the determined ground truth.

The static classification system 250 classifies a software application package as benign or malicious by using a static analysis of the software application package. The analysis is static because it is based on the object code of the APK, but the object code is in a static state and is not executing. The static classification system 250 includes one or more static analysis engines 252 that analyze the object code of the software application package. A static analysis engine 252 analyzes the functionality and structure of the APK based on the static object code. For example, the binary code is decompiled. The entire decompiled binary code or a portion thereof is compared to codes that are identified to be malicious or benign to determine if the binary code is malicious or benign. One or more trained machine learning models may be used to compare the binary codes to known malicious or benign binary codes. A static analysis engine 252 may check for developer certificate signatures, malicious keywords in strings of binary codes, URLs, malicious domain names, known functions calls used in malware, sections of mobile application machine codes or other features of known malicious codes.

A static analysis engine 252 may parse the binary code to identify different software components, and then analyze the software components and their functionality and structure for maliciousness or vulnerability. Examples of software components include an activity, a service, a content provider, a broadcast receiver, and the like. An activity component is a screen with a user interface. A service is a component that runs in the background to perform long-running operations or to perform work for remote processes. A content provider manages a shared set of app data. A broadcast receiver is a component that responds to system-wide broadcast announcements. The static analysis engine 252 may analyze the section of the code that uses services such as broadcast receiver without launching it in a runtime environment to determine whether it is related to malicious function calls.

The dynamic classification system 260 classifies a software application package into as benign or malicious based on behavioral analysis. That is, the dynamic classification system 260 analyzes behavior of the application on a client device to classify a software application package. Behaviors are operations or actions that are performed by the application as it executes on a client device. Example behaviors include usage of specific objects such as semaphores and mutexes, Application Program Interface calls, memory usages, modification of particular system files, and the like. Software application packages are classified based on behavior of the applications. APKs that perform known classes of malicious behavior can be detected and classified as malware. In addition, applications that perform new types of malicious behavior can also be classified as malware. For example, the new malicious behavior may be similar enough to known malicious behavior that the APK can be classified as malware.

In this example, the dynamic classification system 260 includes a behavior observation module 262 and a behavior analysis module 264, which is implemented using machine learning. The dynamic classification system 260 categorizes an application based on the behavior of the application when it is executed. The behavior observation module 262 observes the behavior of the executing application, and the behavior analysis module 264 determines whether this behavior is benign or malicious. The determination may be a sliding scale, such as a confidence level that the behavior is either benign or malicious, rather than a binary decision of either benign or malicious.

The behavior observation module 262 provides a sandbox environment in which an application is executed and monitored. The behavior observation module 262 observes the behavior and generates a representation of the behavior. In this example, the behavior is represented by a behavior token. A behavior token represents a sequence of behaviors and the associated data and objects. A behavior token may include a data token, a behavior unique ID, and a payload data. The behavior token may include a sequence of bits for tracing users' private data, each of which represent different types of private data. If one type of private data is affected, then the corresponding bit is set to 1. If not, it is set to 0. The behavior unique ID identifies a particular behavior. In addition, the payload data comprises information related to objects and/or data (e.g., URL, link, etc.) associated with the particular behavior. The behavior token may be translated into texts describing the application's behavior. A behavior token may further include metadata and parameters associated with actions such as strings, input arguments, local variables, return addresses, system calls, in addition to a binary enumerator denoting a combination of actions.

The behavior observation module 262 exercises the application to determine whether the application exhibits the behaviors in the behavior token. For example, the behavior observation module 262 includes a series of system calls (e.g., Android Kernel system calls) that the application uses to communicate with the kernel of the operation system. Example system calls include special functions or command such as process control, information (e.g., system time, attributes of files and devices) maintenance, communication (e.g., networking, data transfer, attachment/detachment of remote devices), file management, memory management, and device management. A particular system call is identified by a unique ID.

The behavior tokens may include expected or unexpected behaviors performed by the applications. The unexpected behaviors may be considered as anomalous behaviors. Examples of anomalous behaviors may include unusual network transmissions, accessing memories or APIs to obtain data, impressible access of APIs, unusual changes in performance, circumventing denied location accesses, and the like. The behavior token includes behavior features that are individual measurable properties of behavior of an application. A behavior feature includes at least one behavioral trace that is a sequence of system events performed by an application. The behavior feature may include the data related to the system events. For example, the behavior feature of uninstalling and installing an application includes events of application scanning, uninstalling, downloading, unzipping, decrypting, and installing, each of which is associated with detailed information such as a source, a file system location, a decryption algorithm, and the like.

The behavior analysis module 264 classifies the application based on the behavior token. The behavior analysis module 264 uses one or more artificial intelligence models, classifiers, or other machine learning models to classify an application using the behavior token of the application. These models are stored in the model data store 216.

An artificial intelligence model, classifier, or machine learning model is created, for example, by the behavior analysis module 264 to determine correlations between behavior features and categories of applications. In one embodiment, the machine learning models describes correlations between categories of applications and behavior features. Using the behavior token generated for an application, the behavior analysis module 264 identifies the category that is more correlated to the behavior features presented by the software application package.

The machine learning models created and used by the behavior analysis module 264 may include, but are not limited to, logistic regression, support vector machine (SVM), linear SVM, decision trees, and neural network classifiers. The machine learning models created by the behavior analysis module 264 includes model parameters that determine mappings from behavior features of an application to a category of the application (e.g., malicious or benign). For example, model parameters of a logistic classifier include the coefficients of the logistic function that correspond to different behavior features. As another example, the machine learning models created by the behavior analysis module 264 include a SVM model, which is a hyperplane or set of hyperplanes that is maximally far away from any data point of different categories. Kernels are selected such that initial test results can be obtained within a predetermined time frame and tuned to improve detection rates. Initial sets of parameters can be selected based on most comprehensive description of known malware.

The machine learning models used by the behavior analysis module 264 analyze behavior features to identify which behavioral features or combinations thereof can be used to distinguish benign and malicious behavior. The behavior analysis module 264 creates machine learning models (e.g., determines the model parameters) by using training data. The training data includes behavior tokens and the corresponding categories for previously analyzed applications. This can be arranged as a table, where each row includes the behavior token and category for a different application. Based on this training data, the behavior analysis module 264 determines the model parameters for a machine learning model that can be used to predict the category of an application.

After classifying a new software application package, the behavior analysis module 264 includes the behavior token and determined category in the training data. The behavior analysis module 264 may also update machine learning models (e.g., model parameters) using input received from a system administrator or other sources. The system administrator can classify a software application package or overwrite a category of a software application package classified by the analysis system, for example if more reliable information is received from another source. The system administrator may further provide one or more behavior features that are associated with the category of the software application package. The behavior analysis module 264 includes this information in the training data to create new machine learning models or update existing machine learning models.

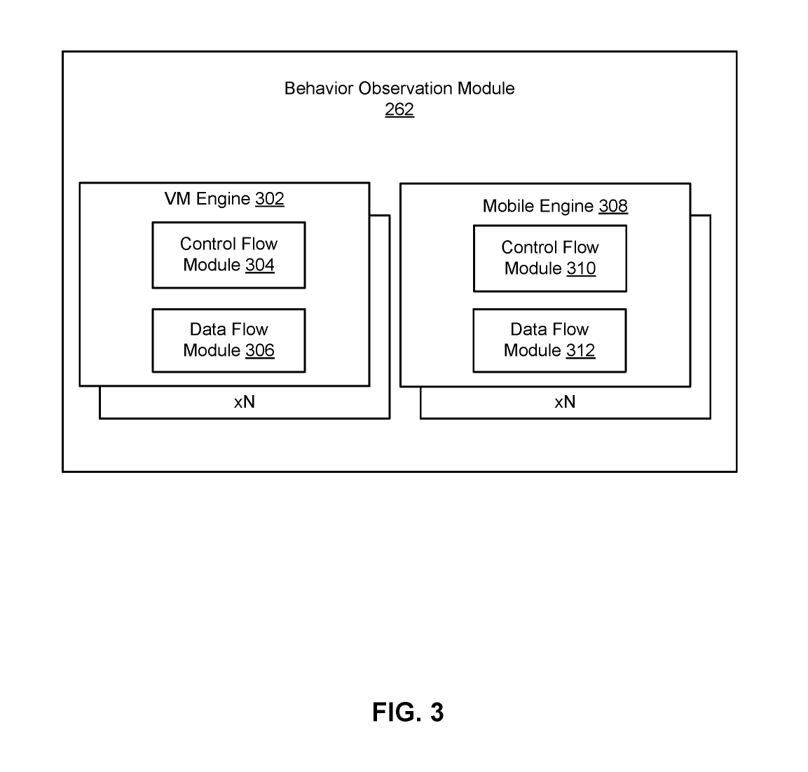

FIG. 3 is a high-level block diagram illustrating a behavior observation module 262 for generating behavior tokens of software application packages, according to one embodiment. The behavior observation module 262 includes instrumented simulation engines for the client devices, which allow the instrumented simulation of client devices. In this example, there are one or more virtual machine (“VM”) engines 302 for computer-like devices, such as laptops and tablets, and one or more mobile engines 308 for lighter weight mobile devices, such as smart phones. A VM engine 302 is a computing system that simulates a client device. For example, the VM engine 302 simulates the architecture and functions of a client device, but it includes additional code (instrumentation) so that the desired behaviors can be observed. The VM engine 302 thereby provides the sandbox or safe run environment in which a software application package operates as if the software application package is operating in the client device that the VM engine 302 emulates. In some embodiments, ROMs of computing systems are configured to include operating systems and user or data images. As such, VM engines 302 can capture and monitor all behavior of an application. A particular software application package may behave differently in different client devices because the different client devices have different hardware architectures and are installed with different operating systems or various versions of an operating system. Accordingly, the behavior observation module 262 includes multiple VM engines 302 to emulate different client devices such that behavior of a software application package on the different client devices can be captured.

In this example, the VM engine 302 includes a control flow module 304 and a data flow module 306. These are two types of dynamic analysis. The control flow module 304 generates a control flow graph of a software application package that includes paths traversed by the corresponding application during its execution. This control flow graph can be analyzed to determine whether certain behaviors have occurred. In a control flow graph, each node represents a basic block. A basic block is a straight-line piece of or a small section of code from the source code building the operating system binary image. The basic block may reveal the actions an application calls in its activity or service and can be used to trace the control flow inside a complied application binary package. The control flow graph therefore can be analyzed to reveal dependencies among basic blocks. As such, a software application package in which malicious code is hidden and cannot be detected by the static analysis engine 206 can be detected because the malicious behavior can be detected by analyzing the control flow graph. For example, any application that uses packer services to encrypt their code can be detected. As one example, an event of sending SMSs to all contacts stored in a device that is automatically triggered by an event of accessing all contacts stored in the device can be uncovered by analyzing a control flow graph of a software application package. As another example, uninstalling and installing an application without a user's permission in the background can be uncovered by analyzing a control flow graph of a software application package.

The data flow module 306 generates flows of data, such as sensitive data, from a data source from which the application obtains the data to a data sink to which the application writes the data. The data source and the data sink are external to the application and the data flows may include intermediate components that are internal to the application. For example, the data source is a memory of a device and the data sink is a network API. Examples of other data sources include input devices such as microphones, cameras, fingerprint sensors, chips, and the like. Examples of other data sinks include speakers, Bluetooth transceivers, vibration actuators, and the like. Different types of information flows between sources and sinks.

The data flow module 306 generates data flows that include behavior features at sufficiently precisions for various types of data sources and data sinks. For example, the generated data flow for a file data source includes information such as file name and user name, and the generated data flow for a network data sink includes information such as IP addresses, SSL certificates, and URLs. Any data of interest can be tagged and the data flow can be tracked across the operating system. As one example, telephone numbers and SMSs can be tagged as sensitive data to detect applications that subscribe paid services on users' expenses. SMSs can be intercepted after paid services are subscribed and the paid service is detected from the service number. The data flows can be analyzed for data that are tracked in the behavior token. Data flows as a result of execution of an application can be used to detect several types of behavior that leaks privacy. For example, an application accessing sensitive information that should not be accessed by the application can be detected. As another example, an application that sends sensitive information to a data sink that is not authorized to receive it can be detected. As a further example, an application that receives data from an untrusted website and writes it to a file meant to hold trustworthy information can be detected.

While the control flow module 304 and the data flow module 306 are described independently above, the control flow module 304 and the data flow module 306 can collaborate to generate the behavior token. For example, the data flow module 306 may generate data flows while the control flow graph is being generated by the control flow module 304 such that the control flow graph includes the data flows. The data flow module 306 can detect a basic block that behaves suspiciously, and the control flow module 304 can confirm that this basic block is regularly exercised.

A mobile engine 308 is a computing system that executes applications on mobile devices. In one embodiment, the mobile engine 308 is run on a mobile phone. The mobile engine 308 includes a control flow module 310 and a data flow module 312. Similar to the control flow module 304, the control flow module 310 generates control flow graphs of a software application package. Similar to the data flow module 306, the data flow module 312 generates data flows of a software application package.

The VM engines 302 and mobile engines 308 facilitate high throughput, flexible, unpolluted user scenario execution by automatically provisioning different ROMs, and initializing applications and data to a defined initial state with preset data and cache of ordinary users. The VM engines 302 and mobile engines 308 ensure that the control flow modules 304 and 310 as well as data flow modules 306 and 312 observe the execution paths of interest by supplying appropriate user input, and collect the output from the control flow modules 304 and 310 and also data flow modules 306 and 312 across managed physical mobile devices.

Compared to mobile engines 308, VM engines 302 can be more cost-efficient than mobile devices because the server hosting VM engines can be used to emulate different client devices, reducing the capital expenditure needed to emulate a given variety of client devices. In addition, VM engines 302 can be more easily configured and managed. A control flow module or data flow module can be more easily implemented on a VM engine 302 because the emulation can be developed by targeting a specific phone type of which an emulator can be easily accessed, whereas a specific mobile device is limited to the production lifetime and existence of hardware.

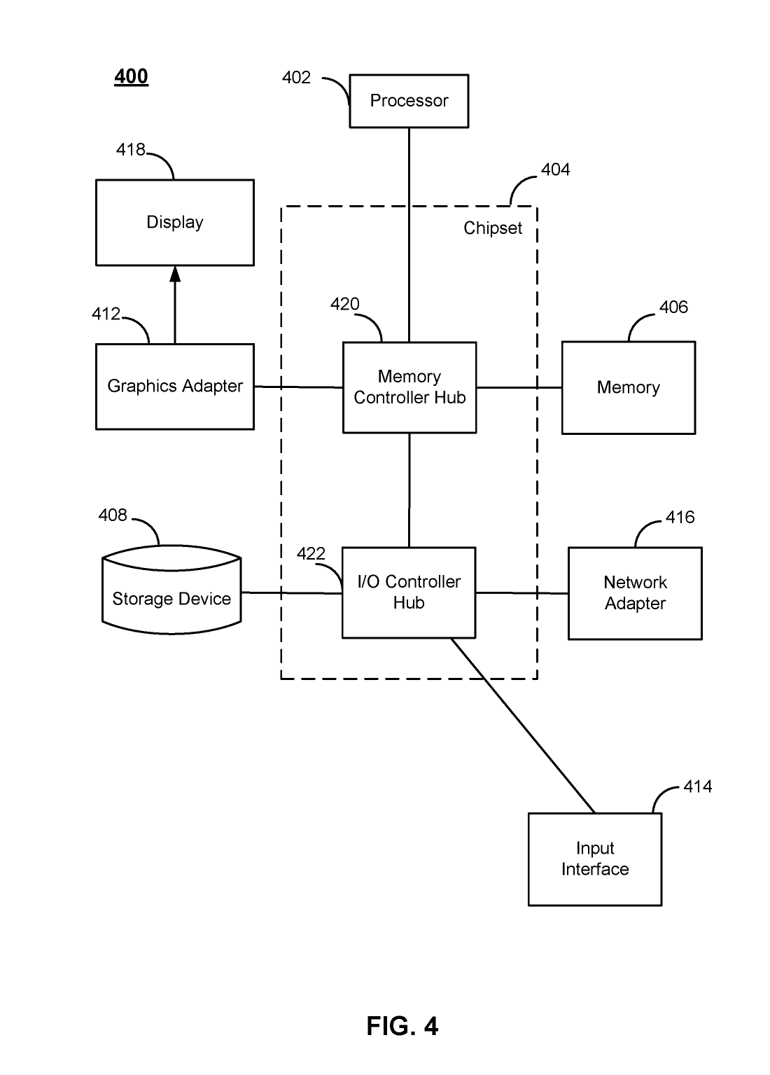

Turning now to a discussion of the implementation the analysis system 140, FIG. 4 is a high-level block diagram illustrating an example computing device 400 for implementing the entities shown in FIG. 1. The computing device 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, an input device 414, and network adapter 416 are coupled to the I/O controller hub 422. Other embodiments of the computing device 400 have different architectures.

The storage device 408 is a non-transitory computer-readable storage medium such as a hard drive, compact disk read-only memory (CD-ROM), DVD, or a solid-state memory device. The memory 406 holds instructions and data used by the processor 402. The input interface 414 is a touch-screen interface, a mouse, track ball, or other type of pointing device, a keyboard, or some combination thereof, and is used to input data into the computing device 400. In some embodiments, the computing device 400 may be configured to receive input (e.g., commands) from the input interface 414 via gestures from the user. The graphics adapter 412 displays images and other information on the display 418. The network adapter 416 couples the computing device 400 to one or more computer networks.

The computing device 400 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 408, loaded into the memory 406, and executed by the processor 402.

The types of computing devices 400 used by the entities of FIG. 1 can vary depending upon the embodiment and the processing power required by the entity. For example, the media service server 130 can run in a single computing device 400 or multiple computing devices 400 communicating with each other through a network such as in a server farm. The computing devices 400 can lack some of the components described above, such as graphics adapters 412, and displays 418.

Some portions of the above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method for determining whether an application package is malicious, the method comprising:
receiving an application package configured for installation on a client device;
executing the application package on an instrumented simulation engine for the client device;
recording which behaviors from a set of behaviors occur during execution of the application package; and
categorizing the application package as benign or malicious based on which behaviors occurred during execution of the application package.

2. The computer-implemented method of claim 1 wherein categorizing the application package as benign or malicious is further based on a machine learning model.

3. The computer-implemented method of claim 2 wherein the machine learning model is based on at least one of logistic regression, support vector machine, linear support vector machine, decision tree, and neural network classifier.

4. The computer-implemented method of claim 2 wherein the machine learning model was trained using training data for prior categorized application packages, the training data comprising which behaviors occurring during execution of the prior categorized application packages and categorization of the prior categorized application packages as benign or malicious.

5. The computer-implemented method of claim 1 wherein categorizing the application package as benign or malicious is further based on at least one of an artificial intelligence model and a classifier.

6. The computer-implemented method of claim 1 wherein categorizing the application package as benign or malicious comprises assigning a confidence that the application package is either benign or malicious.

7. The computer-implemented method of claim 1 wherein the set of behaviors includes at least one of usage of semaphores, usage of mutexes, Application Program Interface calls, memory usages, and modification of pre-identified system files.

8. The computer-implemented method of claim 1 wherein which behaviors occurred during execution of the application package is recorded in a behavior token, and categorizing the application package as benign or malicious is based on the behavior token.

9. The computer-implemented method of claim 8 wherein the behavior token is an enumerator and comprises a data token comprising a set of bits for tracing a user's private data, a behavior unique ID identifying a particular behavior, and payload data comprising information related to an object or data.

10. The computer-implemented method of claim 1 wherein the instrumented simulation engine for the client device is a virtual machine of the client device.

11. The computer-implemented method of claim 1 wherein the instrumented simulation engine for the client device includes a physical client device.

12. The computer-implemented method of claim 1 wherein the instrumented simulation engine includes instrumentation for control flow analysis, and the set of behaviors includes behaviors based on control flow analysis.

13. The computer-implemented method of claim 1 wherein the instrumented simulation engine includes instrumentation for data flow analysis, and the set of behaviors includes behaviors based on data flow analysis.

14. The computer-implemented method of claim 1 wherein the set of behaviors includes a behavior of flow of sensitive data to a component that should not have access to the sensitive data.

15. The computer-implemented method of claim 1 wherein the set of behaviors includes a behavior of flow of data from an untrusted source to a location that holds trustworthy data.

16. The computer-implemented method of claim 1 wherein receiving the application package is responsive to a dedicated application on the client device signaling installing of the application package on the client device.

17. The computer-implemented method of claim 1 wherein the application package is received from an application marketplace.

18. The computer-implemented method of claim 1 further comprising:
crawling an application marketplace; and
receiving application packages identified during crawling the application marketplace.

19. The computer-implemented method of claim 1 wherein the client device can be any one of a smart phone, a tablet, a laptop computer, or a personal computer.

20. The computer-implemented method of claim 1 further comprising:
performing a static analysis of the application package; and
categorizing the application package as benign or malicious based on the static analysis in addition to which behaviors occurred during execution of the application package.

21. A computer program product for determining whether an application package is malicious, the computer program product comprising a non-transitory machine-readable medium storing computer program code for performing a method, the method comprising:
receiving an application package configured for installation on a client device;
executing the application package on an instrumented simulation engine for the client device;
recording which behaviors from a set of behaviors occur during execution of the application package; and
categorizing the application package as benign or malicious based on which behaviors occurred during execution of the application package.

22. An analysis system for determining whether an application package configured for installation on a client device is malicious, the analysis system comprising:
a dynamic classification system comprising:
a behavior observation module including an instrumented simulation engine for the client device, the behavior observation module executing the application package on the instrumented simulation engine and recording which behaviors from a set of behaviors occur during execution of the application package; and
a behavior classification module that categorizes the application package as benign or malicious based on which behaviors occurred during execution of the application package.
